(19) United States
(12) Patent Application Publication
(10) Pub. No.: US 2022/0164885 A1
(43) Pub. Date: May 26, 2022

(54) METHOD AND SYSTEM FOR FULLY-AUTOMATED FULL SPECTRUM DYNAMIC EFFICIENT FRONTIER INVESTMENT ALLOCATION

(71) Applicant: Joseph Gradante, Lake Oswego, OR (US)

(72) Inventor: Joseph Gradante, Lake Oswego, OR (US)

(21) Appl. No.: 17/533,821

(22) Filed: Nov. 23, 2021

Related U.S. Application Data
(60) Provisional application No. 63/118,005, filed on Nov. 24, 2020.

(51) Int. Cl. G06Q 40/06

(52) U.S. Cl. CPC G06Q 40/06

(57) ABSTRACT

The disclosed method and system solves the deficiencies with other previous round-ups to continue to leverage the change spread in transactions and allow them to be applied to micro-share investments, in both ETFs and tokens. It's the combination thereof of traditional, alternative and digital-currency products that gives this invention the ability to simplify the creation of an efficient frontier portfolio construction.

### PRIORITY CLAIM

This application claims priority to U.S. Provisional Patent Application Ser. No. 63/118,005 filed Nov. 24, 2020, the entirety of which is hereby incorporated by reference as if fully set forth herein.

### COPYRIGHT NOTICE

This disclosure is protected under United States and/or International Copyright Laws. © 2020-2021 All-Weather Fintech Corporation. All Rights Reserved. A portion of the disclosure of this patent document contains material that is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### BACKGROUND OF THE INVENTION

Many existing approaches to automate investments have limitations. Acorns (https://www.acorns.com/), for instance, is limited to automated investments and round up investments in the equity and bond Exchange Traded Fund (ETF) fund space. Stash (https://www.stash.com/), offers equities, bonds and gold ETFs, but it isn't fully automated and doesn't have alternative assets like solar, wind, oil, gas ETFs, nor digital assets like Bitcoin, Ethereum, Litecoin, Monero or Crypto ETFs. RoundlyX (https://www.roundlyx.com/) offers investments in digital assets and currency only, like Bitcoin and Ethereum. Thus, the platform is extremely limited in scope and risk intense. The first two approaches rely on an antiquated investment model (Markowitz) that was developed in 1952 in a hawkish monetary environment and the third relies on purely speculative products. Therefore, there is a need for a new method and system that achieves optimal return capacity mitigated for risk.

### SUMMARY OF THE INVENTION

There currently is no round-up application or system that offers an adequate range of assets class diversity in the U.S. The specific construction of digital wallets with traditional security exchanges is unique and disclosed herein.

The disclosed method and system of this round-up application and system solves the deficiencies with other previous round-ups to continue to leverage the change spread in transactions and allow them to be applied to micro-share investments, in both ETFs and tokens. It's the combination thereof of traditional, alternative and digital-currency products that gives this invention the ability to simplify the creation of an efficient frontier portfolio construction. This novel approach will allow retail investors to obtain, automatically, a construction of a portfolio of investment products previously only available to institutional investors that can afford the fees of fund managers to construct such portfolios essentially manually.

### BRIEF DESCRIPTION OF THE DRAWINGS

Preferred and alternative examples of the present invention are described in detail below with reference to the following drawings:

FIGS. 1-3 illustrate a preferred embodiment of the invention.

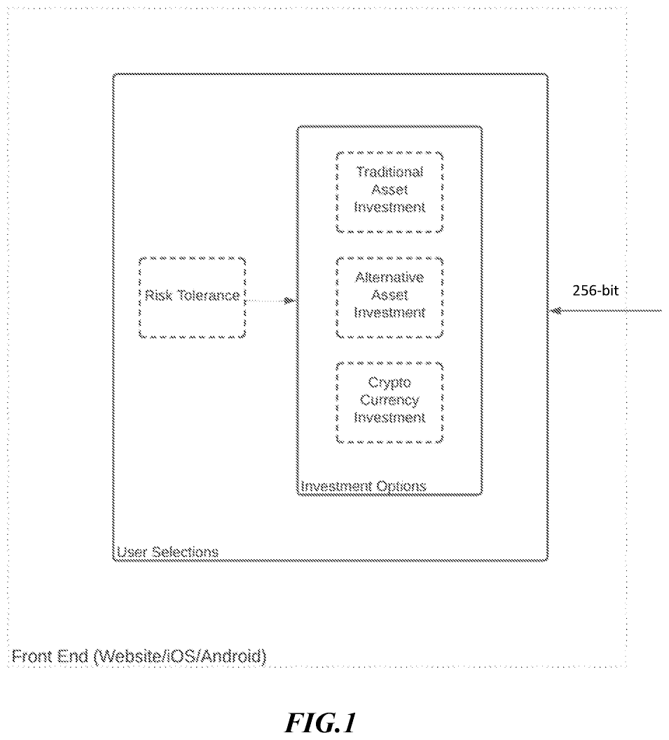

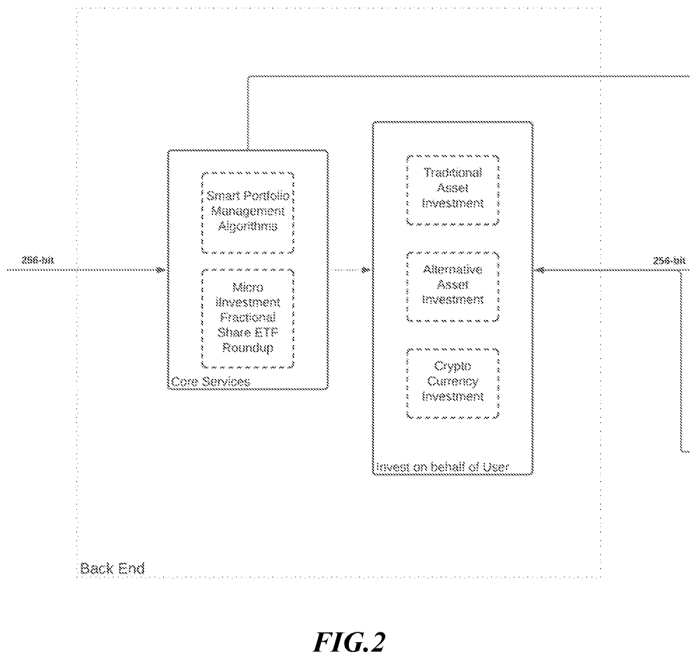

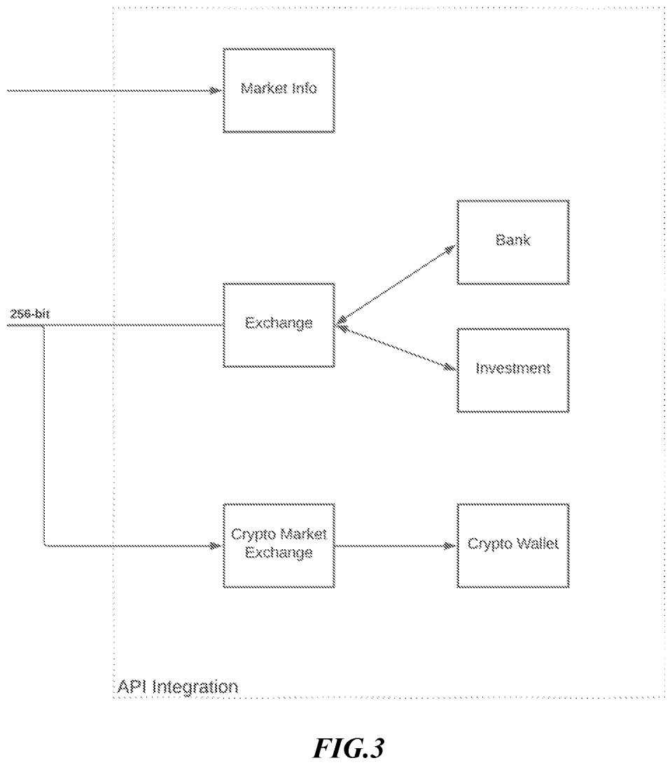

### DETAILED DESCRIPTION OF THE PREFERRED EMBODIMENT

In a preferred embodiment, and by way of non-limiting example, a user logs into the trading platform website at the front end via mobile phone browser, i.e. Google's Android or Apple's iOS operating system, via the trading app downloaded from an app store, or via the trading website. Other operating systems or website interfaces may be used.

The user creates an account or logs into an existing account and answers a series of questions to determine his or her investment risk tolerance in any of the available investment categories, i.e. traditional asset investments (equities, bonds), alternative asset investments (solar, wind, oil, gas, among others) and crypto-currency investments (bitcoin, ethereum or crypto currency ETFs). Any other asset class may also be included.

From there, via encrypted connection, the investing platform analyzes the user's answers via its smart portfolio management algorithms. A model portfolio is created for micro investment fractional share ETF round-up. The round-up feature would give a weighted range of percentages of traditional allocation, alternative allocation and digital allocation predicated on investors risk tolerance and financial goals. (0-50% digital/0-100% traditional/0-100% alternative).

At this point, the system invests the user's funds according to the determined model portfolio percentages. The disclosed system makes micro investment fractional share purchases by communicating via API integration with stock market exchanges, crypto market exchanges, bank and investment accounts and crypto wallets.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A computer-implementable method of automatically constructing an efficient frontier investment portfolio investment allocation, the method comprising the steps of:
compiling an electronic history comprising: (a) at least one identifier of an investor and (b) data identifying the investor's investment preferences and risk tolerance;
storing said electronic history in a memory device;
generating to a display device a user interface within which is displayed input fields for the user to input said investor investment preferences and risk tolerance;
receiving from the user, via the user interface and user input fields, a selection of a first investor preference and tolerance;
in response to the selection of the first preference and tolerance, computing an efficient frontier for a portfolio composition across a full spectrum of possible investments;
generating to a display device a view of portfolio parameters and investments along said efficient frontier;
displaying in the user interface a field for the investor to select investments representing investment options corresponding to the efficient frontier; and
wherein the preceding steps are performed by at least one processor.
